(19) United States
(12) Patent Application Publication
(10) Pub. No.: US 2018/0181605 A1
(43) Pub. Date: Jun. 28, 2018

(54) Binary complemented numerals

(71) Applicant: TROENDLE PETER-PAUL, MERCER ISLAND, WA (US)

(72) Inventor: TROENDLE PETER-PAUL, MERCER ISLAND, WA (US)

(21) Appl. No.: 14/999,262

(22) Filed: Apr. 14, 2016

(51) Int. Cl. G06F 17/30; G06F 5/01

(52) U.S. Cl. CPC G06F 17/30339; G06F 5/01

(57) ABSTRACT

The length information in data streams is possible when and only when a second bit is given that can be complemented (inverted) or non-complemented (identical) and that indicates when a data element is bound to the neighboring ones or separated. The length information important to the software engineering when becoming part of the data makes the data handling simpler because the structure information is distinguishable also in variable size data streams then. The termination of a size uses the NULL in software and now it is also possible in digital streams to have additionally to the 0 and 1 that NULL element that abstractly represents the end of the length and makes possible for variable sizes of data and structure information

### BACKGROUND

### Field of the Invention

The invention characterizes itself by complemented bits that separate data by indicating its length EXAMPLE: Data streams that has variable sizes of data would be possible by it

### Description of the Related Art

All internet signals at the PHY RJ45 connector use the Manchester encoding that use the complemented bit of the clock data to pass the information. In the Manchester encoding a second datastream is needed it is used for signal balancing reasons and synchronization of the recipient clock.

The CMOS complementary metal oxide semiconductor technology used a second bit transistor that complements the first for the improvement of the signal switching no other related methods are known to make variable sizes of data possible

### SUMMARY

Data streams that has variable sizes of data

Data streams that has contain structure information

### BRIEF DESCRIPTION OF THE DRAWINGS

FIG. 1 shows a spacial representation for a binary number length

FIG. 6 shows a second stream used to distinguish that number geometrically

FIG. 14 shows a second stream used to distinguish that number digitally

FIG. 19 shows the data extracted from the stream

FIG. 2 shows an empty space that separates two points in space

FIG. 3 shows a filled space that joins two points in a geometric line

FIG. 4 shows a point that corresponds to one bit bound to the group on the line

FIG. 5 shows a point that corresponds to one bit unbound to the group on the line

FIG. 7 represented by 0 defines the empty space separating the data bit with value=1 as on FIG. 11

FIG. 10 shows any empty space anywhere referred more commonly to as the NULL

FIG. 8 represented by 1 defines the space joining the data bit with value=0 as on FIG. 13

FIG. 9 shows the group of bits of that length represented by the unit value=1

FIG. 12 shows the unit length value=1 in geometrical representation

FIG. 16 shows the non-complemented bit from the bit on FIG. 15

FIG. 18 shows the complemented bit from the bit o FIG. 17

### DETAILED DESCRIPTION

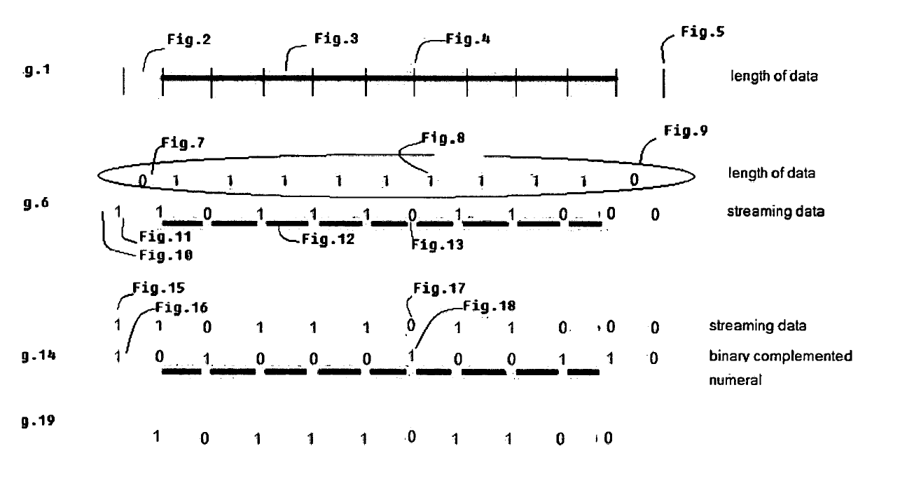

The issue with handling real time data that is in different sizes is that to assess the length of the respective data a second datastream is needed. In FIG. 1 the abstract idea of a data length is shown geometrically with FIG. 2 that illustrates the ending using an empty space and FIG. 3 illustrates the joining by a line that is filling the space, the separator/point on FIG. 4 shows that the data bit is included in the group and the point FIG. 5 that the data bit is excluded.

In FIG. 6 the data length is shown geometrically using unit value=0 to show the bit separation as in FIG. 7 or the unit value=1 to show the bit binding as in FIG. 8 and it is apparent that a group of bits defining a data element can be defined as in FIG. 9 using the length information such as on FIG. 12. The data bit that is separated as in FIG. 11 is distinct from those that are bound as the bit in FIG. 13

If one is aligning the geometric length bits from FIG. 9 with the binary bits it selects here in particular the bits extracted shown in FIG. 12, then we see that a shift is present and that the data don't overlap digitally because the number of bits that indicates bindings are less that the number of bits of the data. 9 Bits are used to define the 10 Bits of data.

So the method proposed use the complemented numeral stream where the data is separated by the Complemented data as in FIG. 17 bit=NOT FIG. 18 bit or non-complemented as in FIG. 15 bit=FIG. 16 bit where we see how data of any length can be read from a stream using XOR logic that allow to distinguish a data in a stream, making it possible for any size and adding structure information In FIG. 19 we see the data sample that is wrapped in NULL as mentioned in FIG. 10 for any empty space

1. The usage of a second data bit that complements or non-complements (copies) that allows to distinct data from one another
